(19) United States
(12) Patent Application Publication
(10) Pub. No.: US 2025/0242785 A1
(43) Pub. Date: Jul. 31, 2025

(54) STEERING-BASED BRAKING SYSTEM

(71) Applicants: DENSO International America, Inc., Southfield, MI (US); DENSO CORPORATION, Kariya-City (JP)

(72) Inventors: Swanand LIMAYE, Farmington Hills, MI (US); Guriqbal SINGH, Belle River (CA); Kenji MORIKAWA, Kariya-City (JP); Sergio PUJOLS, Canton, MI (US); Robert BRINKER, Ortonville, MI (US)

(73) Assignees: DENSO International America, Inc., Southfield, MI (US); DENSO CORPORATION, Kariya-City (JP)

(21) Appl. No.: 18/979,886

(22) Filed: Dec. 13, 2024

Related U.S. Application Data
(60) Provisional application No. 63/624,815, filed on Jan. 25, 2024.

(51) Int. Cl. B60T 8/1755; B60T 8/32; B60W 10/18; B60W 30/02; B60W 50/00

(52) U.S. Cl. CPC B60T 8/17551; B60T 8/3205; B60W 10/18; B60W 30/02; B60W 50/0097; B60T 2220/04; B60T 2250/03; B60W 2050/0008; B60W 2420/503; B60W 2520/105; B60W 2520/14; B60W 2520/26; B60W 2540/12; B60W 2540/18; B60W 2556/10

(57) ABSTRACT

An electric vehicle steering system including a vehicle controller, steering controller, braking controller, and a steering actuator. The vehicle controller, in cooperation with the steering and braking controllers, is responsible for collecting and processing various vehicle conditions to determine a braking application. The steering controller, linked to steering actuators, executes braking application instructions from the vehicle controller. The braking controller, connected to the vehicle's braking system, executes instructions to apply brakes as needed.

### CROSS-REFERENCE TO RELATED APPLICATION

This application claims the benefit of U.S. Provisional Application No. 63/624,815, filed on Jan. 25, 2024. The entire disclosure of the above application is incorporated herein by reference.

### FIELD

The present disclosure relates to a steering-based braking system.

### BACKGROUND

This section provides background information related to the present disclosure, which is not necessarily prior art.

Electric vehicles have predominantly utilized a centralized powertrain architecture. This conventional design typically includes a single electric motor or a pair of motors that drive the vehicle, which are connected to the wheels through a transmission system. Conventional electric powertrains feature a standard, centralized arrangement of components, including the motor, transmission, steering system, braking system, and often a battery pack.

### SUMMARY

This section provides a general summary of the disclosure, and is not a comprehensive disclosure of its full scope or all of its features.

The present disclosure provides for, in various features, an electric vehicle steering system, including: a vehicle controller in cooperation with a steering controller and a braking controller, and configured to collect and process one or more vehicle conditions and determine a braking application instruction based on the vehicle conditions; the braking controller in cooperation with a braking system of a vehicle and configured to receive and execute the braking application instruction from the vehicle controller, the steering controller in cooperation with a steering wheel and one or more steering actuators and configured to receive and execute the braking application instruction from the vehicle controller, and the steering actuator in cooperation with a knuckle assembly and configured to control an angle of rotation of the knuckle assembly, wherein the braking application instruction comprises the angle of rotation for one or more knuckle assemblies and wherein the braking application instruction results in the one or more knuckle assemblies being placed in a first divergent position or a second divergent position.

In various additional features, wherein the one or more vehicle conditions include one or more of vehicle speed, vehicle acceleration, vehicle yaw rate, vehicle steering angle, and wheel slip, and wherein each vehicle condition is received from one or more sensors or determined from a signal received from one or more sensors.

In various additional features, the system further includes a tire assembly in cooperation with each of the one or more knuckle assemblies.

In various additional features, the system is included in a module configured to be attached to a platform for an electric vehicle.

In various additional features, the one or more knuckle assemblies include one or more front knuckle assemblies and one or more rear knuckle assemblies, and the one or more front knuckle assemblies may be placed in the first divergent position or the second divergent position and the one or more rear knuckle assemblies may be placed in the first divergent position or the second divergent position.

In various additional features, the one or more sensors include a wheel speed sensor, a brake pedal position sensor, and/or a vehicle stability control sensor.

In various additional features, the vehicle controller is further configured to determine the vehicle steering angle based on the vehicle's yaw rate and vehicle speed, and the steering controller adjusts the angle of rotation of the one or more knuckle assemblies to improve vehicle stability.

In various additional features, the first divergent position is a toed-in position and the second divergent position is a toed-out position.

In various additional features, the system further includes a feedback loop between the braking controller and the steering controller, wherein the braking application instruction is dynamically adjusted based on real-time changes in vehicle wheel slip.

In various additional features, the steering controller is further configured to execute steering adjustments in cooperation with an autonomous or semi-autonomous driving system.

In various additional features, the knuckle assembly is adjustable to a range of intermediate angles between the first divergent position and the second divergent position.

In various additional features, the braking application instruction is based on predictive vehicle conditions determined using an artificial intelligence module in communication with the vehicle controller, wherein the artificial intelligence module determines vehicle conditions at least based on historical driving patterns.

The present disclosure includes, in various features, an electric vehicle steering system, including a vehicle controller in cooperation with a steering controller and a braking controller, and configured to collect and process one or more vehicle conditions and determine a braking application instruction based on the vehicle conditions, the braking controller in cooperation with a braking system of a vehicle and configured to receive and execute the braking application instruction from the vehicle controller, the steering controller in cooperation with a steering wheel and one or more steering actuators and configured to receive and execute the braking application instruction from the vehicle controller, the steering actuator in cooperation with one or more knuckle assemblies and configured to control an angle of rotation of the one or more knuckle assemblies, wherein the braking application instruction comprises the angle of rotation for the one or more knuckle assemblies and wherein the braking application instruction results in the one or more knuckle assemblies being placed in a first divergent position or a second divergent position, and a tire assembly in cooperation with each of the one or more knuckle assemblies.

In various additional features, the one or more vehicle conditions include one or more of vehicle speed, vehicle acceleration, vehicle yaw rate, vehicle steering angle, and wheel slip, and each vehicle condition is received from one or more sensors or determined from a signal received from one or more sensors.

In various additional features, the electric vehicle steering system is included in a module configured to be attached to a platform for an electric vehicle.

In various additional features, the one or more sensors include a wheel speed sensor, a brake pedal position sensor, and/or a vehicle stability control sensor.

In various additional features, the first divergent position is a toed-in position and the second divergent position is a toed-out position.

In various additional features, the electric vehicle steering system further includes a feedback loop between the braking controller and the steering controller, wherein the braking application instruction is dynamically adjusted based on real-time changes in vehicle wheel slip.

In various additional features, the steering controller is further configured to execute steering adjustments in cooperation with an autonomous or semi-autonomous driving system.

In various additional features, the knuckle assembly is adjustable to a range of intermediate angles between the first divergent position and the second divergent position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle platform with four electric vehicle propulsion, steering, and suspension systems according to the present disclosure;

FIG. 2 illustrates one of the electric vehicle propulsion, steering, and suspension systems of FIG. 1;

FIG. 3 is a schematic view of a brake-by-wire system according to the present disclosure installed in an exemplary vehicle;

FIG. 4 is a block diagram of a brake-by-wire system according to the present disclosure;

FIG. 5 is a block diagram of an electric vehicle steering system according to the present disclosure;

FIG. 6A is a plan view of the vehicle platform of FIG. 1 illustrating a front tire assembly in a parallel orientation;

FIG. 6B is a plan view of the vehicle platform of FIG. 1 illustrating a first divergent orientation of the front tire assembly; and

FIG. 6C is a plan view of the vehicle platform of FIG. 1 illustrating a second divergent orientation of the front tire assembly.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The present disclosure advantageously decentralizes the powertrain into four independent modules, each integrated into a wheel of the vehicle. This approach allows for a more flexible vehicle design, as it eliminates the need for a central powertrain and transmission shaft, leading to a more efficient use of space and potentially reducing the vehicle's overall weight.

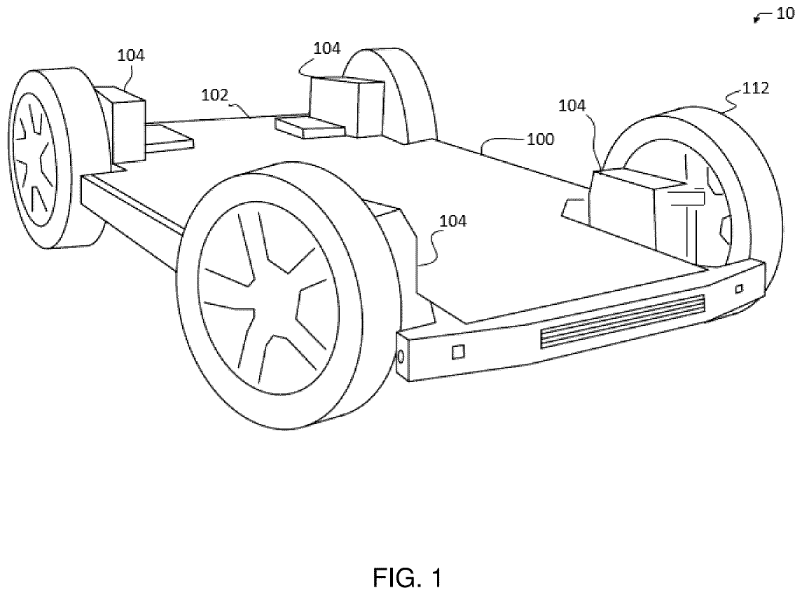

FIG. 1 illustrates an example platform assembly 100 for an electric vehicle 10 configured as a skateboard chassis. The platform assembly 100 may alternatively be configured as any other suitable electric vehicle platform. The teachings of the present disclosure apply to any suitable electric vehicles, such as, plug-in hybrid electric vehicle (PHEV), battery electric vehicle (BEV), range-extended electric vehicles (REEV), etc. The platform assembly 100 is particularly configured for pickup trucks, but the platform assembly 100 may alternatively be configured for light trucks, sporty utility vehicles (SUVs), crossover utility vehicles (CUVs), vans, and off-road vehicles, etc.

The platform assembly 100 includes a main body 102 and at least one electric vehicle propulsion, steering, and suspension system 104. In one example, the electric vehicle propulsion, steering, and suspension system 104 may be packaged as a module. The module may be a self-contained assembly including all of the features of the electric vehicle propulsion, steering, and suspension system. The module may be configured to attach to the main body of a platform assembly. The module may further include a braking element and an anti-locking braking system (ABS). Examples of a braking element include, but are not limited to disc brakes, drum brakes, and electromagnetic brakes.

The module may include a “plug and play” design to allow the module to more easily connect to the chassis or main body 102. Once attached to the chassis or main body 102, the module may be secured with a plurality of bolts or a single bolt. A plurality of bolts may include two bolts, three bolts, four bolts, five bolts, or more.

The module may further include a plurality of connection points, including coolant lines, HV cables, and communication cables. These connections may connect to, or interface with, matching connection points on the chassis or main body 102. The module may be configured to be attached to a vehicle platform on a production line.

The main body 102 forms the foundational structure. The main body 102 may contain a battery (not shown). As illustrated, the main body 102 may be physically connected to four electric vehicle propulsion, steering, and suspension systems 104, but the main body 102 may alternatively be configured having a greater or lesser number of electric vehicle propulsion, steering, and suspension systems 104. The electric vehicle propulsion, steering, and suspension system is discussed in more detail below.

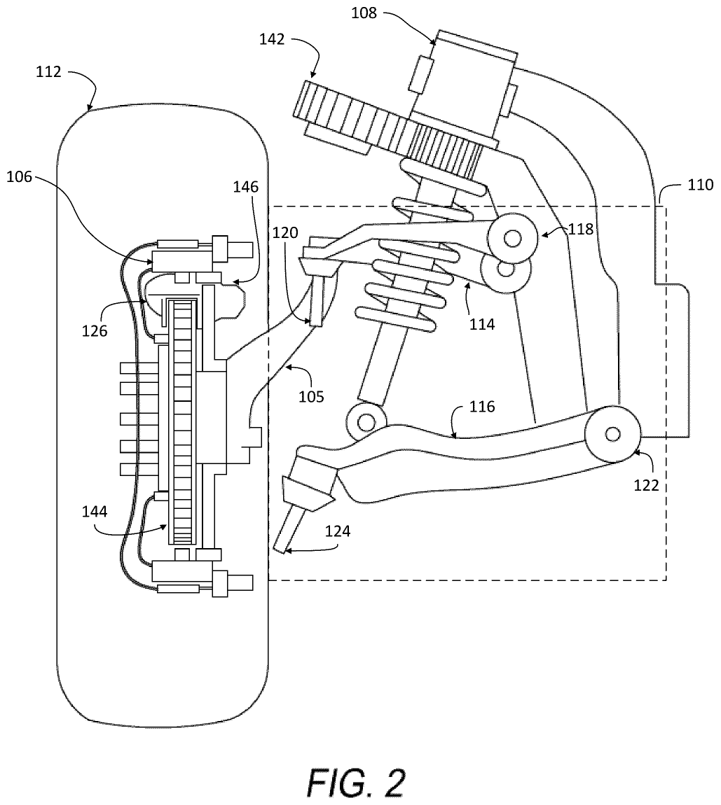

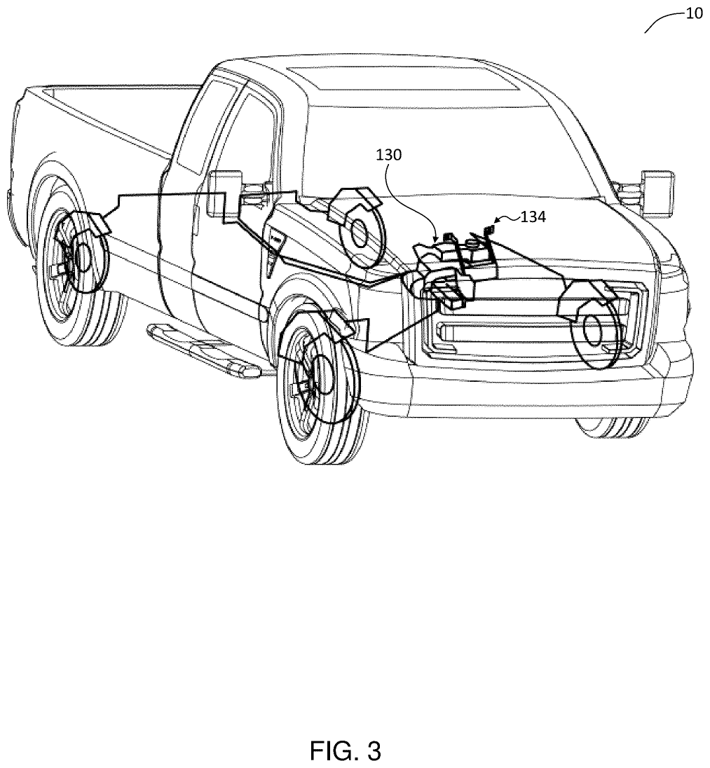

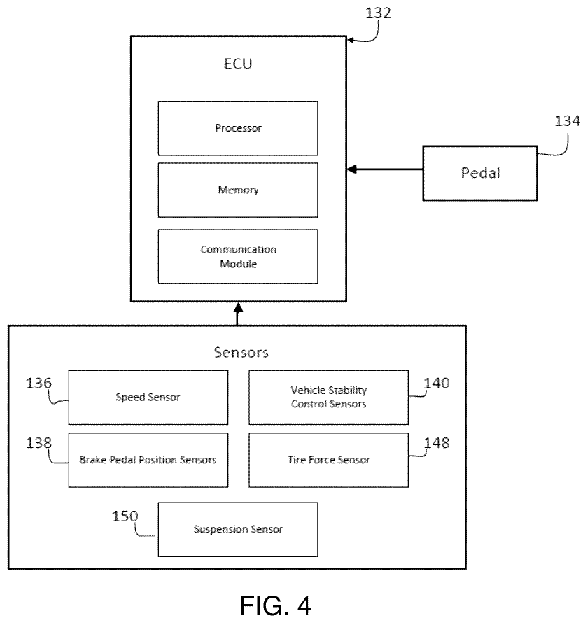

FIG. 2 illustrates an example electric vehicle propulsion, steering, and suspension system 104. Each electric vehicle propulsion, steering, and suspension system 104 includes an in-wheel motor 106, an integrated inverter 107, a direct steering motor 108, a brake-by-wire system 130 (FIGS. 3A and 3B, for example), and a double-wishbone suspension 110.

The in-wheel motor 106 may be located within, or proximate, to a tire assembly 112. The in-wheel motor 106 may be an electric drive motor (EDM). The in-wheel motor 106 may be positioned around a brake actuator 126 and rotor 144, thereby forming a ring within the tire assembly 112. The in-wheel motor 106 may be configured to drive the tire of the tire assembly 112.

The direct steering motor 108 may be attached to the top of the electric vehicle propulsion, steering, and suspension system 104. The direct steering motor 108 may include an electric motor coupled to a gear assembly 142.

The gear assembly 142 may be further coupled to the double-wishbone suspension such that, when the gear assembly is rotated by the direct steering motor 108, the electric vehicle propulsion, steering, and suspension system is rotated.

The brake-by-wire system 130 (see FIG. 3, for example), may include an electronic control unit (ECU) 132, a number of brake actuators 126, a pedal 134, at least one wheel speed sensor 136, at least one brake pedal position sensor 138, and at least one vehicle stability control sensor 140. The ECU 132 may receive input from a number of sensors, including, but not limited to, wheel speed sensors 136, brake pedal position sensors 138, and vehicle stability control sensors 140. The ECU 132 processes this data to determine the appropriate braking force for each wheel, ensuring optimal braking performance under varying conditions. Each tire assembly 112 is equipped with a brake actuator 126, which directly applies the braking force to the wheel. The brake actuator 126 may include or be a component of a hydraulic, electronic, or magnetic braking system. These actuators 126 are controlled by the ECU 132 and are capable of precise and rapid modulation of braking force.

As illustrated in FIG. 2, for example, the double-wishbone suspension 110 includes an upper wishbone arm 114 and a lower wishbone arm 116, each having at least one proximal end point 118, 120 and at least one distal end point 122, 124 (proximal indicating the end point nearest the center of the vehicle 10 and distal indicating the end point furthest from the center of the vehicle 10). The proximal end points of both arms 114, 116 are pivotally connected to the chassis of the vehicle, allowing for vertical movement. The distal end points of the arms 114, 116 are connected to a knuckle assembly 105, which, in turn, is attached to the tire assembly 112.

The double-wishbone suspension typical of light trucks presents design challenges for an electric vehicle propulsion, steering, and suspension system 104. The electric vehicle propulsion, steering, and suspension system 104 requires a large number of components to occupy a limited amount of space in the tire assembly 112. The double-wishbone suspension 110 is particularly configured to accommodate the space needs of these components.

The lower wishbone arm 116 has been shortened relative to a typical double-wishbone suspension to accommodate the space needs of the components and reduce the unsprung mass of the vehicle 10. The length of the lower wishbone arm may be reduced proportionally to the reduction of the distance between the upper wishbone arm 114 and lower wishbone arm 116. In another example, a subframe design may be used allowing the electric vehicle propulsion, steering, and suspension system to move with the wheel.

The upper wishbone arm 114 has also been lowered relative to the tire assembly to reduce the overall height of the electric vehicle propulsion, steering, and suspension system and increase the size of the frunk space. Lowering the upper wishbone arm reduces the distance between the upper wishbone arm 114 and the lower wishbone arm 116, and alters the roll center of the vehicle. The roll center is a virtual point in a vehicle around which the chassis rolls, significantly influencing handling during cornering. Torque vectoring techniques may be applied to address the changes in the vehicle roll center.

For example, applying torque directly through the in-wheel motors 106 to each wheel and selectively steering each wheel according to real-time feedback provided by vehicle sensors may improve stability. In another example, torque vectoring may include algorithmic control and monitoring of a number of vehicle sensors including a tire force sensor 148 which measures the force being applied to a tire by the pavement. Algorithmic control and monitoring of sensors may further include, but is not limited to, other common vehicle sensors, such as the wheel speed sensors 136 and sensors monitoring the motion of the suspension 150.

The unsprung mass is that part of the vehicle that is not supported by springs (e.g. tires, nuts, linkages). This is an especially important concern in an electric vehicle propulsion, steering, and suspension system because the electric vehicle propulsion, steering, and suspension system 104 moves components, such as the electric drive motor, into the wheel, increasing the unsprung mass. An increased unsprung mass results in a slower wheel reaction time to events like potholes, meaning it takes longer for the wheel to rise back from the pothole due its mass. This extra mass has an overall impact on handling and stability. In another example, the torque vectoring techniques described above may be applied to overcome the handling issues introduced by the increased unsprung mass.

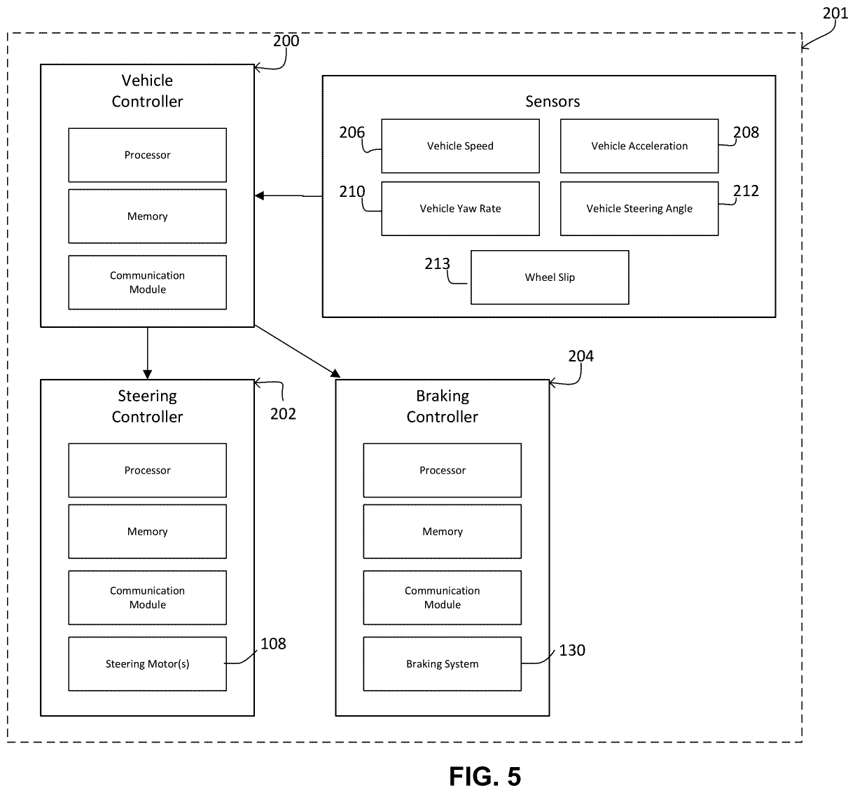

FIG. 5 illustrates an example block diagram of an electric vehicle steering system 201 for applying steering-based braking techniques. The system includes a vehicle controller 200 in cooperation with a steering controller 202 and a braking controller 204. Though each controller is in cooperation with each other controller, it should be understood that this coupling may be direct or indirect, wired or wireless. In one example, the cooperation between controllers is facilitated through intermediary components. In another example, the cooperation between controllers is facilitated through both wired and wireless communications.

The vehicle controller 200, which may be a Vehicle Control Unit (VCU) or Electronic Control Unit (ECU), may be in cooperation with the steering controller 202 and the braking controller 204. The vehicle controller 200 collects vehicle conditions from an array of sensors, such as sensors collecting information regarding the vehicle speed 206, vehicle acceleration 208, vehicle yaw rate 210, vehicle steering angle 212, and vehicle wheel slip 213. The collection of vehicle conditions may be performed passively by receiving a stream of signals from the sensors. Once the vehicle conditions are received, the vehicle controller 200 determines the vehicle's dynamic state based on the vehicle conditions in real-time. For example, the vehicle controller 200 may determine that the vehicle's dynamic state is braking, accelerating, or experiencing reduced traction on one or more wheels.

Steering controller 202 may be in cooperation with one or more steering motors 108. The steering controller 202 may be tasked with receiving and executing braking application instructions for one or more steering motors 108. These instructions may include an instruction to one or more steering motors 108 to change the angle of rotation of the tire assembly 112 in cooperation with the steering motor 108. Changing the angle of rotation of a tire assembly 112 may result in a change in the slip angle of the tire assembly 112 and a braking force being applied to the tire assembly 112 as a result of the change in the slip angle. In one example, the steering controller 202 may further be in cooperation with an autonomous or semi-autonomous driving system and may execute steering adjustments based on instructions received from the autonomous or semi-autonomous driving system.

Braking controller 204 is in cooperation with the vehicle's brake-by-wire system 130. The braking controller 204 executes braking application instructions received from the vehicle controller 200. The braking application instructions may be based on the vehicle's dynamic state.

The vehicle controller 200 collects vehicle conditions to determine the vehicle's dynamic state and assesses whether one or more braking application instructions are required and, if so, whether the one or more braking application instructions should be sent to the braking controller, steering controller, or a combination thereof is required. Based on this assessment, the vehicle controller 200 determines and sends the appropriate braking application instructions to the steering controller 202 for steering-based braking and the braking controller 204 for conventional braking, respectively. If sent to the steering controller, the appropriate braking application instructions may include an angle of rotation for one or more tire assemblies 112. The steering controller may apply the angle of rotation to improve vehicle stability.

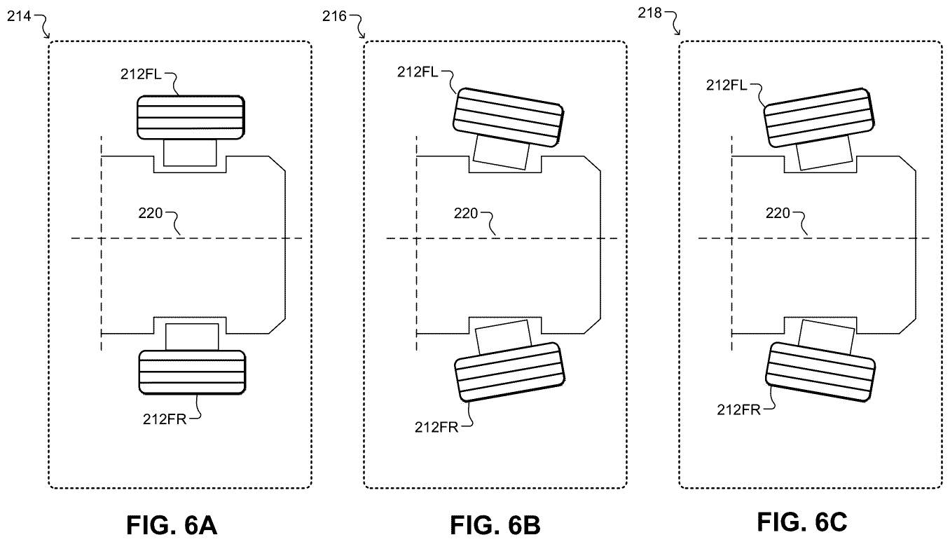

FIGS. 6A-6C illustrate a plan view of the front tire assemblies 212FL, 212FR of an example vehicle platform assembly 100 in a parallel position 214 (FIG. 6A), first divergent position 216 (FIG. 6B), and second divergent position 218 (FIG. 6C).

In the parallel position 214, the front tire assemblies 212FL, 212FR are aligned parallel to the longitudinal axis 220 of the vehicle 10. The vehicle 10 in the parallel position may be considered a default state of the front tire assemblies 212FL, 212FR when no steering-based braking is applied.

In the first divergent position (or “toed-in” position) 216, the front tire assembles 212FL, 212FR angle inwards towards the center longitudinal axis 220 and towards the front of the vehicle 10. In the second divergent position (or “toed-out” position) 216, the front tire assembles 212FL, 212FR angle outwards away from the center longitudinal axis 220 and away from the front of the vehicle 10. The vehicle controller 200 may determine that steering-based braking should be applied by the steering controller 202. In this event, the vehicle controller 200 may transmit braking application instructions to the steering controller 202, which place the front tire assemblies 212FL, 212FR in the first divergent position 216 or the second divergent position (or “toed-out” position) 218. Though the examples in FIGS. 6A-6C illustrate braking application positions of the front tire assemblies 212FL, 212FR, the platform assembly may alternatively be configured with other positions including front and rear tire assemblies. In one example, the rear and front tire assemblies may be in a first divergent position. In another example, the rear tire assembly may be in the first divergent position and the front tire assembly may be in a second divergent position that is different from the first divergent position. In another example, the rear and front tire assemblies may both be in the second divergent position. In another example, the rear tire assembly may be in the second divergent position and the front tire assembly may be in the first divergent position.

Braking is achieved in the first divergent position 216 or second divergent position 218 by the change in the angle of rotation of the tire assemblies 212FL, 212FR and resultant change in the slip angle of the tire assemblies 212FL, 212FR. The slip angle of a tire assembly is the angle between the direction of the tire assembly and the actual direction of vehicle travel. Altering the slip angle may introduce a braking force to a vehicle. When the slip angle is increased beyond an optimal grip angle, the lateral frictional forces generate a resistance to the vehicle's motion, which manifests as a braking force. In the present example, this change in the slip angle of the tire assemblies 212FL, 212FR results in a braking force being applied to the tire assemblies 212FL, 212FR. This helps reduce load and wear on the braking system.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

As used herein, the phrase at least one of A, B, and C should be construed to mean a logical (A OR B OR C), using a non-exclusive logical OR. For example, the phrase at least one of A, B, and C should be construed to include any one of: (i) A alone; (ii) B alone; (iii) C alone; (iv) A and B together; (v) A and C together; (vi) B and C together; (vii) A, B, and C together. The phrase at least one of A, B, and C should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the terms “module,” “controller,” “electronic control unit (ECU),” and “vehicle control unit (VCU)” may be replaced with the term “circuit.” The terms “module,” “controller,” “electronic control unit (ECU),” and “vehicle control unit (VCU)” may refer to, be part of, or include processor hardware (shared, dedicated, or group) that executes code and memory hardware (shared, dedicated, or group) that stores code executed by the processor hardware.

A module, controller, ECU, or VCU may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

A module, controller, ECU, or VCU may communicate with other modules or controllers using the interface circuit(s). Although the module or controller may be illustrated in the present disclosure as logically communicating directly with other modules or controllers, in various implementations the module or controller may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of a module, controller, ECU, or VCU may be distributed among multiple modules that are connected via the communications system. For example, multiple modules may implement the same functionality distributed by a load balancing system. In a further example, the functionality of the module, controller, ECU, or VCU may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules or controllers. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic@, Lua, MATLAB, SIMULINK, and Python@.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. An electric vehicle steering system, comprising:
a vehicle controller configured to collect and process one or more vehicle conditions and determine a braking application instruction based on the vehicle conditions;
a braking controller in cooperation with the vehicle controller and a braking system of the vehicle, configured to receive and execute the braking application instruction from the vehicle controller; and
a steering controller in cooperation with the vehicle controller, a steering wheel, and one or more steering actuators, configured to receive and execute the braking application instruction from the vehicle controller;
wherein the one or more steering actuators, in cooperation with one or more knuckle assemblies, is configured to control an angle of rotation of the knuckle assembly, wherein the braking application instruction comprises the angle of rotation for the one or more knuckle assemblies and wherein the braking application instruction results in the one or more knuckle assemblies being placed in a first divergent position or a second divergent position non-orthogonal to a direction of travel, thereby providing a braking force.

2. The electric vehicle steering system of claim 1, wherein the one or more vehicle conditions include one or more of vehicle speed, vehicle acceleration, vehicle yaw rate, vehicle steering angle, and wheel slip; and
wherein each vehicle condition is received from one or more sensors or determined from a signal received from one or more sensors.

3. The electric vehicle steering system of claim 1, further comprising a tire assembly in cooperation with each of the one or more knuckle assemblies.

4. The electric vehicle steering system of claim 1 included in a module configured to be attached to a platform for an electric vehicle.

5. The electric vehicle steering system of claim 1, wherein the one or more knuckle assemblies comprise one or more front knuckle assemblies and one or more rear knuckle assemblies; and
wherein the one or more front knuckle assemblies may be placed in the first divergent position or the second divergent position and the one or more rear knuckle assemblies may be placed in the first divergent position or the second divergent position.

6. The electric vehicle steering system of claim 2, wherein the one or more sensors include a wheel speed sensor, a brake pedal position sensor, and/or a vehicle stability control sensor.

7. The electric vehicle steering system of claim 2, wherein the vehicle controller is further configured to determine the vehicle steering angle based on the vehicle's yaw rate and vehicle speed; and
wherein the steering controller adjusts the angle of rotation of the one or more knuckle assemblies to improve vehicle stability.

8. The electric vehicle steering system of claim 1, wherein the first divergent position is a toed-in position and the second divergent position is a toed-out position.

9. The electric vehicle steering system of claim 2, further comprising a feedback loop between the braking controller and the steering controller, wherein the braking application instruction is dynamically adjusted based on real-time changes in vehicle wheel slip.

10. The electric vehicle steering system of claim 1, wherein the steering controller is further configured to execute steering adjustments in cooperation with an autonomous or semi-autonomous driving system.

11. The electric vehicle steering system of claim 1, wherein the knuckle assembly is adjustable to a range of intermediate angles between the first divergent position and the second divergent position.

12. The electric vehicle steering system of claim 1, wherein the braking application instruction is based on predictive vehicle conditions determined using an artificial intelligence module in communication with the vehicle controller, wherein the artificial intelligence module determines vehicle conditions at least based on historical driving patterns.

13. An electric vehicle steering system, comprising:
a vehicle controller configured to collect and process one or more vehicle conditions and determine a braking application instruction based on the vehicle conditions, wherein the one or more vehicle conditions include one or more of vehicle speed, vehicle acceleration, vehicle yaw rate, vehicle steering angle, and wheel slip, and wherein each vehicle condition is received from one or more sensors or determined from a signal received from one or more sensors;
a braking controller in cooperation with the vehicle controller and a braking system of the vehicle, configured to receive and execute the braking application instruction from the vehicle controller; and
a steering controller in cooperation with the vehicle controller, a steering wheel, and one or more steering actuators, configured to receive and execute the braking application instruction from the vehicle controller;
wherein the one or more steering actuators, in cooperation with one or more knuckle assemblies, is configured to control an angle of rotation of the knuckle assembly, wherein the braking application instruction comprises the angle of rotation for the one or more knuckle assemblies and wherein the braking application instruction results in the one or more knuckle assemblies being placed in a first divergent position or a second divergent position non-orthogonal to a direction of travel, thereby providing a braking force; and
a tire assembly in cooperation with each of the one or more knuckle assemblies.

14. The electric vehicle steering system of claim 13, wherein the one or more vehicle conditions include one or more of vehicle speed, vehicle acceleration, vehicle yaw rate, vehicle steering angle, and wheel slip; and
wherein each vehicle condition is received from one or more sensors or determined from a signal received from one or more sensors.

15. The electric vehicle steering system of claim 13 included in a module configured to be attached to a platform for an electric vehicle.

16. The electric vehicle steering system of claim 14, wherein the one or more sensors include a wheel speed sensor, a brake pedal position sensor, and/or a vehicle stability control sensor.

17. The electric vehicle steering system of claim 13, wherein the first divergent position is a toed-in position and the second divergent position is a toed-out position.

18. The electric vehicle steering system of claim 14, further comprising a feedback loop between the braking controller and the steering controller, wherein the braking application instruction is dynamically adjusted based on real-time changes in vehicle wheel slip.

19. The electric vehicle steering system of claim 13, wherein the steering controller is further configured to execute steering adjustments in cooperation with an autonomous or semi-autonomous driving system.

20. The electric vehicle steering system of claim 13, wherein the knuckle assembly is adjustable to a range of intermediate angles between the first divergent position and the second divergent position.
